(19) United States
(12) Patent Application Publication
(10) Pub. No.: US 2009/0251890 A1
(43) Pub. Date: Oct. 8, 2009

(54) LAMP TUBE AND DESK LAMP HAVING THE SAME

(75) Inventors: Wen-Hsiang Chien, Taipei (TW); Wen-Chin Lin, Taipei (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: ADVANCED CONNECTEK INC., Taipei (TW)

(21) Appl. No.: 12/177,165

(22) Filed: Jul. 22, 2008

(30) Foreign Application Priority Data
Apr. 3, 2008 (TW) 97112174

(51) Int. Cl. F21V 33/00; F21V 21/00; F21L 4/00; H05B 37/00

(52) U.S. Cl. 362/127; 315/86; 362/183

(57) ABSTRACT

The present invention relates to a lamp tube suitable for a desk lamp. The lamp tube includes a lamp cover, a light-emitting module, a base, a power-storage element and a power transmission module. The lamp tube is half-cylindrical and has a inner surface and a containing recess. The inner surface is capable of being fixed with the light-emitting module and the containing recess is capable of containing the power-storage element. The power transmission module is electrically connected to the power-storage element and the light-emitting module to transmit the power in the power-storage element to the light-emitting module. The present invention is also relates to a desk lamp having the lamp tube.

### CROSS-REFERENCE TO RELATED APPLICATION

This application claims the priority benefit of Taiwan application serial no. 97112174, filed on Apr. 3, 2008. The entirety of the above-mentioned patent application is hereby incorporated by reference herein and made a part of this specification.

### BACKGROUND OF THE INVENTION

1. Field of the Invention

The present invention generally relates to a desk lamp, in particular, to a desk lamp having a lamp tube. The lamp tube is capable of lighting when being unloaded from the desk lamp.

2. Description of Related Art

Generally, a conventional desk lamp is disposed on the table for providing lighting while users are reading. The function of lighting fails when the electricity is lost. Specifically, since there's no emergency lighting in residences, the properties of users may be in danger when the electricity is lost at night.

Even if an emergency lighting is equipped in residences, the emergency lighting is often equipped on the wall. The function of emergency lighting will be started when the electricity is lost in daytime. Although the emergency lighting can turned off through a switch, it is still inconvenient for the users.

### SUMMARY OF THE INVENTION

Accordingly, the present invention is directed to provide a lamp tube capable of being charged independently. The lamp tube is capable of providing lighting continuously when the electricity is lost.

The present invention is directed to provide a portable lamp tube. The lamp tube is capable of replacing a flashlight and provides lighting.

The present invention is directed to provide a desk lamp having the above-mentioned lamp tube. The desk lamp having the above-mentioned lamp tube is capable of providing lighting under ordinary or emergent situation, or capable of being used as a flashlight when the electricity is lost.

According to the concept of the present invention, the lamp tube including a lamp cover, a light-emitting module, a base, a power-storage element and a power transmission module is provided. The lamp cover is half-cylindrical and comprises an inner surface and a containing recess. The inner surface can be fixed with the containing recess which is capable of containing the power-storage element. The power transmission module is electrically connected to the power-storage element to the light-emitting module so as to transmit the power stored in the power-storage element to the light-emitting module.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a perspective view showing the preferred embodiment of the lamp tube of the present invention.

FIG. 2 is an exploded view showing the lamp tube in FIG. 1.

FIG. 3 is a cross-sectional view showing the lamp cover in FIG. 1.

FIG. 4 is a perspective view showing the light-emitting module of the lamp tube in FIG. 1.

FIG. 5 is a perspective view showing the fixing element of the lamp tube in FIG. 1.

FIG. 6 is a perspective view showing the power-storage element of the lamp tube in FIG. 1.

FIG. 7A is a perspective view showing the power transmission module of the lamp tube in FIG. 1.

FIG. 7B is another perspective view showing the power transmission module of the lamp tube FIG. 1.

FIG. 8 is a perspective view showing the desk lamp comprising the lamp tube and the lamp base of the present invention.

FIG. 9 is a circuit schematic diagram showing the desk lamp comprising the lamp tube and the lamp base in FIG. 8.

### DESCRIPTION OF THE EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

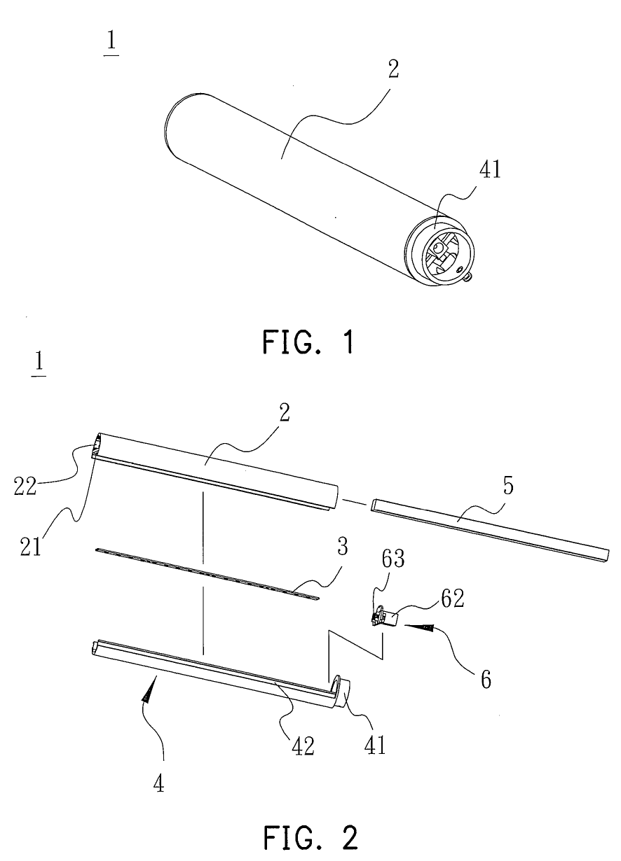

Referring to FIGS. 1 and 2, the lamp tube 1 of the present invention comprises a lamp cover 2, a light-emitting module 3, a base 4, a power-storage element 5 and a power transmission module 6.

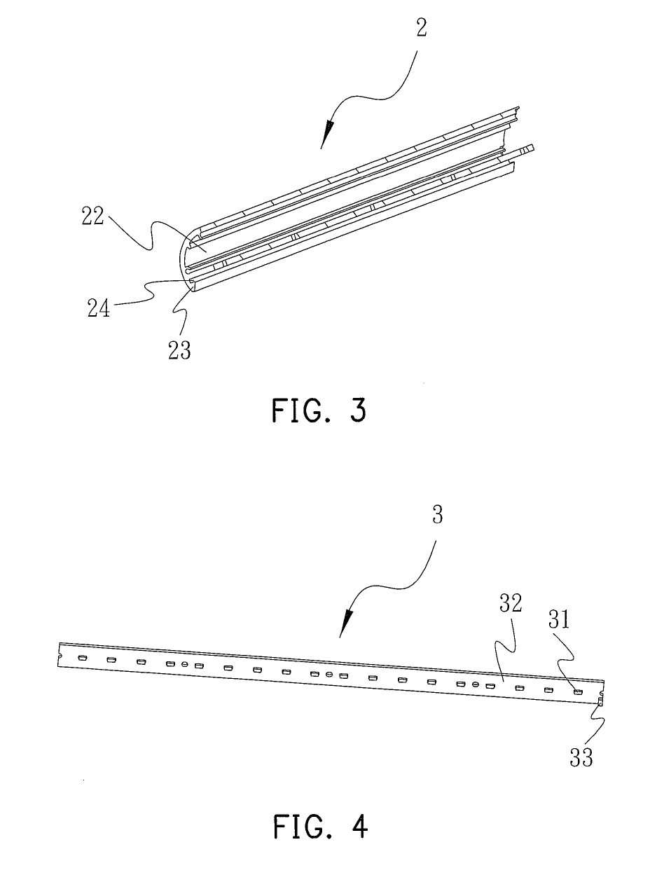

Referring to FIGS. 2 and 3, the lamp cover 2 is half-cylindrical and comprises an inner surface 21 and a containing recess 22. The inner surface 21 is capable of being fixed with the light-emitting module 3, and the containing recess 22 is capable of containing the power-storage element 5. Two hooking bars 23 is disposed at the two sides of the surface opposite to the containing recess 22 of the inner surface 21, and there is a sliding rail 24 between the two hooking bars 23 and the inner surface 21 for the base 4 to be inserted into the sliding rail 24 and be fixed with the lamp cover 2 by the two hooking bars 23.

The lamp cover 2 is made of aluminum or Al—Mg alloy by extrusion to provide a great heat dissipating function.

Referring to FIG. 4, the light-emitting module 3 comprises a plurality of light-emitting devices 31, a printed circuit board 32 and a power supply port 33. The plurality of light-emitting devices 31 are all disposed on the same side of the printed circuit board 32 and electrically connected to the printed circuit board 32. The other side of the printed circuit board 32 is contacted with the inner surface 21 of the lamp cover 2 to dissipate the heat generated by the plurality of light-emitting devices 31 by the lamp cover 2. The power supply port 33 is disposed on the printed circuit board 32 and electrically connected to the power-storage element 5 so as to transmit the power to the light-emitting module 3 and generate light.

The light-emitting device 31 can be a lighting element, such as a light bulb or a LED.

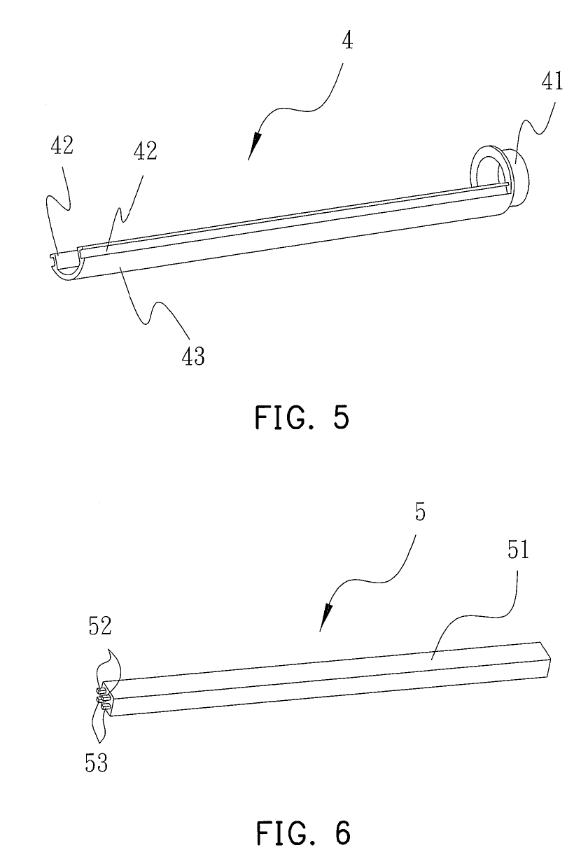

Referring to FIG. 5, the base 4 comprises a fixing element 41 and two fixing bars 42. The fixing element 41 is cylindrical. The two fixing bars 42 are linked perpendicularly to the fixing element 41 and are capable of being inserted into the sliding rail 24 of the lamp cover 2. The base 4 and the lamp cover 2 are fixed together by the fixing bars 42 and the hooking bars 23. Furthermore, the base 4 comprises a transparent part 43. The transparent part 43 is disposed between the two fixing bars 42 to permit the light generated by the light-emitting module 3 pass through and provide lighting when the base 4 is fixed with the lamp cover 2. Besides, the transparent part 43 is capable of preventing the dust or foreign body from entering the light-emitting module 3.

The base 4 is made of plastic. The transparent part 43 is also capable of being made of plastic by injection molding when the base 4 is fabricated.

Referring to FIG. 6, the power-storage element 5 comprising a battery assembly 51, a power input port 52 and a power output port 53 is disposed in the containing recess 22 of the lamp cover 2. The battery assembly 51 is electrically connected to the power input port 52 and the power output port 53, and the power input port 52 is electrically connected to the power transmission module 6. Thus, the battery assembly 51 is capable of being charged by the power from the power input port 52. The power output port 53 is electrically connected to the power supply port 33 of the light-emitting module 3 such that the light-emitting module 3 provides lighting when receiving the power from the battery assembly 51.

The battery assembly 51 can be a lithium-ion battery assembly or other battery assembly capable of being charged and discharged.

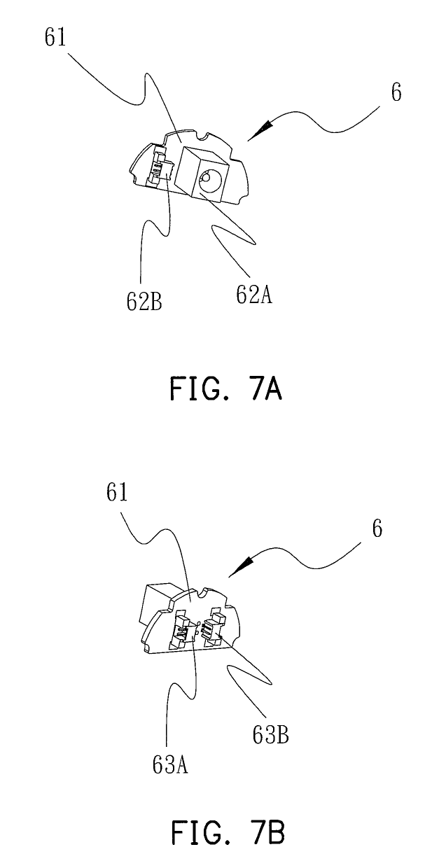

Referring to FIGS. 7A and 7B, the power transmission module 6 comprises a fixing plate 61, a plurality of power input connectors 62 and a plurality of power output connectors 63. All the power input connectors 62 are disposed on the same side of the fixing plate 61, and all the power output connectors 63 are disposed on the other side of the fixing plate. Each of the power input connectors 62 is electrically connected to one of the power output connectors 63, respectively. In this embodiment, the number of the power input connectors 62 and the power output connectors 63 are both two. One first power input connector 62A, one second power input connector 62B, one first power output connector 63A and one second power output connector 63B are illustrated here.

Referring to FIG. 2, the power transmission module 6 is disposed at the contact position of the fixing element 41 and the two fixing bars 42 on the base 4. The power output connectors 63 extend along the extension direction of the two fixing bars 42 such that it is convenient to electrically connect the to power output connectors 63 with the light-emitting module 3 and the power-storage element 5. In this embodiment, the two power input connectors 63 are the first power input connector 62A and the second power input connector 62B, and the two power output connectors 63 are the first power output connector 63A and the second power output connector 63B. The first power input connector 62A is electrically connected to the first power output connector 63A, and the second power input connector 62B is electrically connected to the second power output connector 63B. Besides, referring to FIG. 9, the first power output connector 63A is electrically connected to the power supply port 33 of the light-emitting module 3, and the second power input connector 62B is electrically connected to the power input port 52 of the power-storage element 5.

During the assembly process, the power-storage element 5 is disposed in the containing recess 22 of the lamp cover 2 made by extrusion. The light-emitting module 3 is disposed on the inner surface 21 of the lamp cover 2 such that the light-emitting devices 31 of the light-emitting module 3 face outside. The power transmission module 6 is disposed on the contact position of the fixing element 41 and the two fixing bars 42 on the base 4 made by injection molding process, and the two fixing bars 42 is then inserted into the sliding rail 24 defined by the hooking bars 23 of the lamp cover 2 and the inner surface 21. The first power output connector 63A of the power transmission module 6 is electrically connected to the power supply port 33 of the light-emitting module 3. The second power output connector 63B is electrically connected to the power input port 52 of the power-storage element 5. The power output port 53 of the power-storage element 5 is electrically connected to the power supply port 33 of the light-emitting module 3. Thus, the lamp tube 1 of the present invention is assembled completely.

Referring to FIG. 9, in order to make it convenient to turn on or turn off the lamp tube 1, the lamp tube 1 comprises a first switch 7. The first switch 7 is electrically connected to the power output port 53 of the power-storage element 5 and the power supply port 33 of the light-emitting module 3 such that the users can turn on or turn off the lamp tube 1 via the first switch 7. When the first switch 7 is at the first position 71, the power output port 53 of the power-storage element 5 and the power supply port 33 of the light-emitting module 3 are electrically connected, and the light-emitting module 3 are driven by power provided from the power-storage element 5. When the first switch 7 is at the second position 72, the power output port 53 of the power-storage element 5 and the power supply port 33 of the light-emitting module 3 are open, and no power is provided from the power-storage element 5 to the light-emitting module 3.

When the lamp tube 1 is required to be charged or is electrically connected to the external power, the power input connector 62 is electrically connected to the external power supply. The power input connectors 62 are electrically connected to the power output connectors 63, i.e., the first power output connector 63A is electrically connected to the first power input connector 62A and the second power output connector 63B is electrically connected to the second power input connector 62B in this embodiment. Since the first power output connector 63A is electrically connected to the power supply port 33 of the light-emitting module 3, the lamp tube 1 provides lighting without charging the power-storage element 5 when the first power input connector 62A is electrically connected to the external power supply. Since the second power output connector 63B is electrically connected to the power input port 52 of the power-storage element 5, the power-storage element 5 in the lamp tube 1 is charged when the second power input connector 62B is electrically connected to the external power supply. At this time, the lamp tube 1 stilled can be turned on or turned off via the first switch 7.

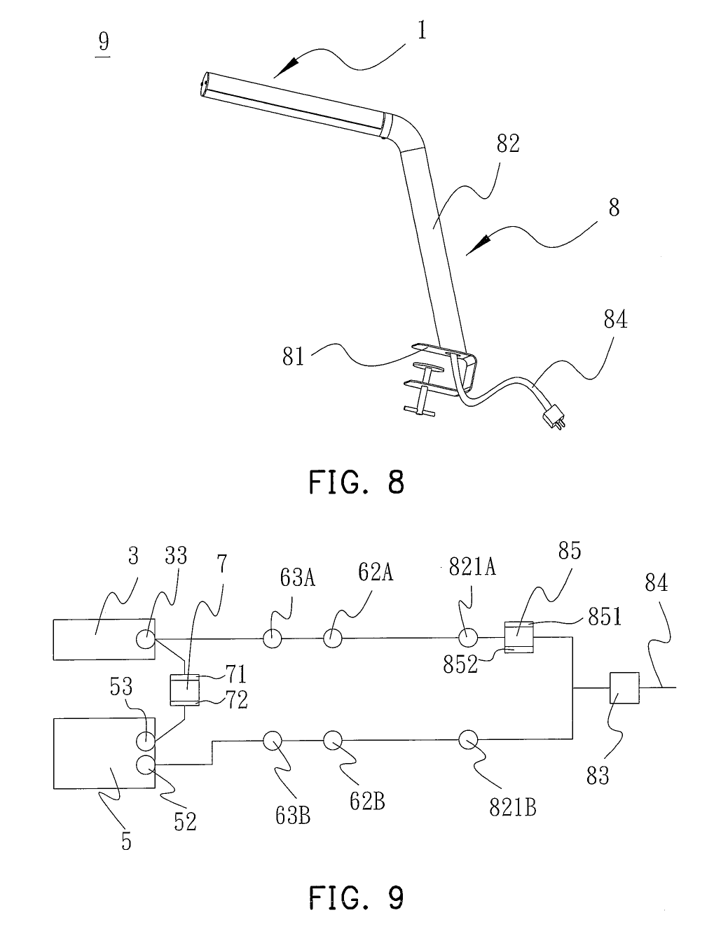

Referring to FIGS. 8 and 9, the lamp tube 1 is capable of being disposed on a lamp base 8 to accomplish a desk lamp 9. The lamp base 8 comprises a lamp fixing base 81, a lamp arm 82, a transformer 83, an electric wire 84 and a second switch 85.

The lamp fixing base 81 is capable of being disposed on or locked on a table such that the desk lamp 9 is disposed or locked on the table firmly.

One end of the lamp arm 82 is linked to the lamp fixing base 81, and the other end of the lamp arm 82 is capable of being fixed with the fixing element 41 of the base 4. In order to provide power to the lamp tube 1, the end of the lamp arm 82 capable of being fixed with the fixing element 41 of the base 4 comprises a plurality of power supply connectors 821 capable of being electrically connected to the plurality of power input connectors 62 of the power transmission module 6. In this embodiment, the power supply connectors 821 comprise a first power supply connector 821A capable of being electrically connected to the first power input connector 62A and a second power supply connector 821B capable of being electrically connected to the second power input connector 62B.

The transformer 83 is capable of transforming the voltage of the external power into a predetermined voltage level which is suitable for the power-storage element. In this embodiment, the external power is transformed into 12V direct current (DC). The transformer 83 is capable of being disposed on the lamp fixing base 81 or in the lamp arm 82 and transmits the transformed power to the power supply connectors 821. In this embodiment, the transformer 83 is disposed on in the lamp arm 82 and transmits the transformed power to the first power supply connector 821A and the second power supply connector 821B.

The electric wire 84 is electrically connected to the transformer 83 and is capable of being electrically connected to the external power supply to transmit the external power to the transformer 83.

The second switch 85 is electrically connected to the transformer 83 and the first power supply connector 821A to turned on or turned off the lamp tube 1. When the second switch 85 is at the third position 851, the transformed power provided by the transformer 83 is transmitted to the light-emitting module 3 through the first power input connector 62A, the first power output connector 63A and the power supply port 33 so as to turn on the light-emitting devices 31 of the light-emitting module 3. When the second switch 85 is at the fourth position 852, the transformed power provided by the transformer 83 is not transmitted to the light-emitting module 3. Therefore, the users can turn on or turn off the desk lamp 1 via the second switch 85.

To sum up, since the lamp tube of the present invention has the power-storage element capable of being charged independently and the power input connector, the lamp tube can provide lighting continuously when external power is cut.

According to the present invention, since the lamp tube comprises the power-storage element to provide power independently, the lamp tube is portable and is capable of replacing a flashlight.

According to the present invention, the lamp tube is capable of being disposed on a lamp base to form a desk lamp which is capable of providing lighting whether there's external power supply or not and being used as a flashlight in unloaded state.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A lamp tube, comprising:
a lamp cover having an inner surface and a containing recess, wherein two hooking bars are disposed on the two sides of the inner surface and a sliding rail is disposed between the two hooking bars and the inner surface;
a light-emitting module disposed on the inner surface of the lamp cover and comprising a plurality of light-emitting devices, a printed circuit board and a power supply port, wherein the light-emitting devices are disposed on the same side of the printed circuit board, the other side of the printed circuit board is contacted with the inner side of the lamp cover, and the power supply port is disposed on the printed circuit board;
a base fixed with the lamp cover and comprising a fixing element and two hooking bars, wherein the fixing element is cylindrical, and the hooking bars linked perpendicularly to the fixing element are capable of being inserted into the sliding rail of the lamp cover;
a power-storage element disposed in the containing recess of the lamp cover and comprising a battery assembly, a power input port, and a power output port, wherein the battery assembly is electrically connected to the power input port and the power output port, and the power output port is electrically connected to the power supply port of the light-emitting module; and
a power transmission module disposed on a contact position of the fixing element and the fixing bars on the base and comprising a fixing plate, a plurality of power input connectors, and a plurality of power output connectors, wherein the power input connectors are disposed on the same side of the fixing plate, the power output connectors are disposed on the other side of the fixing plate, each of the power input connectors is electrically connected to one of the power output connectors respectively, one of the power output connectors is electrically connected to the power supply port of the light-emitting module, and one of the power output connectors is electrically connected to the power input port of the power-storage element.

2. The lamp tube according to claim 1, wherein the material of the lamp cover is aluminum.

3. The lamp tube according to claim 1, wherein the material of the lamp cover is Al—Mg alloy.

4. The lamp tube according to claim 1, wherein the light-emitting device is a light-emitting diode (LED).

5. The lamp tube according to claim 1, wherein the material of the base is plastic.

6. The lamp tube according to claim 1, wherein the base comprises a transparent part between the two fixing bars.

7. The lamp tube according to claim 1, wherein the battery assembly is a lithium-ion battery assembly.

8. The lamp tube according to claim 1, wherein the power output connectors of the power transmission module extend along an extension direction of the two fixing bars.

9. The lamp tube according to claim 1, wherein the lamp tube comprises a first switch electrically connected to the power output port of the power-storage element and the power supply port of the light-emitting module.

10. A desk lamp comprising:
the lamp tube according to claim 1 and
a lamp base comprising a lamp fixing base, a lamp arm, a transformer, an electric wire, and a second switch, wherein one end of the lamp arm is linked to the lamp fixing base, the other end of the lamp arm is capable of being fixed with the fixing element of the base, the lamp arm comprises the power supply connectors capable of being electrically connected to the power input connectors of the power transmission module, the transformer is electrically connected to the electric wire and the power input connectors, and the second switch is electrically connected to the transformer and the power supply connectors capable of being electrically connected to the light-emitting module.

11. The desk lamp according to claim 10, wherein the transformer is disposed in the lamp fixing base.

12. The desk lamp according to claim 10, wherein the transformer is disposed in the lamp arm.
